(19) United States
(12) Patent Application Publication
(10) Pub. No.: US 2020/0234091 A1
(43) Pub. Date: Jul. 23, 2020

(54) IMAGE INSPECTION DEVICE, IMAGE FORMING SYSTEM, IMAGE INSPECTION METHOD, AND RECORDING MEDIUM

(71) Applicant: KONICA MINOLTA, INC., Tokyo (JP)

(72) Inventors: Jun ITOU, Tokyo (JP); Makoto OKI, Tokyo (JP)

(73) Assignee: KONICA MINOLTA, INC., Tokyo (JP)

(21) Appl. No.: 16/744,546

(22) Filed: Jan. 16, 2020

(30) Foreign Application Priority Data
Jan. 21, 2019 (JP) 2019-007755

(51) Int. Cl. G06K 15/02; G06T 7/00; G06T 7/73

(52) U.S. Cl. CPC G06K 15/027; G06T 2207/30176; G06T 7/73; G06T 7/0004

(57) ABSTRACT

An image inspection device includes a hardware processor. The hardware processor (i) captures a read image from a reading device that optically reads a paper sheet output from an image forming device that forms an image on the paper sheet, (ii) aligns a reference image and an inspection image obtained by reading the paper sheet on which an image corresponding to the reference image has been formed with the reading device, at feature points in the images for comparison, and (iii) after performing emphasis processing based on a bias in a detecting direction of an image edge on an image in a feature point extraction region of each of the reference image and the inspection image, performs alignment of the feature points.

### CROSS-REFERENCE TO RELATED APPLICATIONS

The entire disclosure of Japanese Patent Application No. 2019-007755 filed on Jan. 21, 2019 is incorporated herein by reference in its entirety.

### BACKGROUND

### Technological Field

The present invention relates to an image inspection device, an image forming system, an image inspection method, and a recording medium.

### Description of the Related Art

Usually, when performing high-volume printing, test printing is performed several times to make various adjustments, and in a case where it is confirmed from a proof that there is no problem in print details, production printing is started. However, chromatic aberration or distortion may occur in an image on a paper sheet obtained by production printing with respect to the proof because of some factor. Thus, in recent years, a scanner is provided on a conveyance path in a stage subsequent to an image forming device, and an image on each paper sheet being printed and output is read with the scanner for inspection. In this inspection, an image read with the scanner when printing and outputting the proof is stored as a reference image, and an image (inspection image) obtained by reading a paper sheet printed in production printing with the scanner is compared with the stored reference image.

In the case of comparing images, it is common to compare the images after extracting feature points in the respective images, calculating the amount of deviation in rotation angle, the amount of deviation in magnification (X/Y), the amount of deviation in shift (X/Y), and the like on the basis of the positional relationship between the feature points, and performing image correction (affine transformation or the like) on the basis of the amounts of deviation.

As described above, image alignment significantly contributes to the inspection accuracy when performing image inspection by comparing images. Therefore, it is important to perform alignment with high accuracy.

As a technology of aligning images for inspection, there is disclosed a technology of dividing each of images to be compared into a plurality of fine regions, aligning respective divided regions to detect differences, and determining whether or not alignment has been performed correctly on the basis of whether differences exceeding a threshold value concentrate on specific divided regions, or the like (for example, see JP2015-59744A).

There is also disclosed a technology of detecting skew at the time of reading from a corner of a paper sheet, and in a case where a streak detected from a read image has not moved in the main scanning direction with respect to this skew value, determining the streak as being a scanner streak to perform processing of excluding the scanner streak from image inspection (for example, see JP2014-155113A).

There is also disclosed a technology of calculating the amount of positional deviation in reference point, and excluding a portion with a large difference from an image comparison region (for example, see JP2014-199248A).

### SUMMARY

However, in a case of reading an image in-line with a scanner provided in a stage subsequent to an image forming device of an electrophotographic system or the like, there are various problems in addition to fluctuations in position and angle of paper sheets targeted for reading. For example, in a case where information about an edge direction obtained from a read image (user content) is obtained in a biased manner in either the main scanning direction or the sub scanning direction, alignment (matching) with a similar feature point in the vicinity may be performed (for example, a phenomenon in which, in a case where an image edge at the end of a thin ruled line cannot be acquired, alignment is performed at a place displaced in the horizontal direction), which raises a problem in that alignment cannot be performed correctly.

A conventional example of image alignment and image inspection is schematically shown in FIG. 11.

First, four regions (feature point extraction regions E31 to E34 corresponding to the four corners) for extracting feature points are set for a reference image G3 (see FIG. 11a). Similarly, four feature point extraction regions E41 to E44 are set for an inspection image G4 (see FIG. 11b).

Next, feature points FP31 to FP33 are extracted from images of the feature point extraction regions E31 to E34 set for the reference image G3 (see FIG. 11c). Similarly, feature points FP41 to FP43 are extracted from images in the feature point extraction regions E41 to E44 set for the inspection image G4 (see FIG. 11d). In the example shown in FIG. 1 la to FIG. 11d, since only a small image such as a page number can be detected in the lower feature point extraction regions E33 and E34 (or the feature point extraction regions E43 and E44), the feature points FP31 to FP33 (or the feature points FP41 to FP43) at three positions, rather than four positions, are extracted.

Next, the feature points FP31 to FP33 and the feature points FP41 to FP43 as extracted are compared (analyzed) to calculate the amount of positional deviation (the amount of deviation in rotation angle (the amount of rotational deviation), the amount of deviation in magnification (X/Y) (the amount of magnification deviation), the amount of deviation in shift (X/Y) (the amount of shift deviation)) (see FIG. 11e).

Next, image correction (affine transformation or the like) is performed on the reference image G3 on the basis of the calculated amount of positional deviation to perform alignment (matching) of feature points (see FIG. 11f). Thereafter, the reference image G31 after the image correction and the inspection image G4 (see FIG. 11g) are compared to perform image inspection.

In the example shown in FIG. 11, since the image edge at the end of a thin ruled line (whose number of pixels in the longitudinal direction is small) cannot be acquired precisely (see the reference character FP31 in FIG. 11c), alignment (matching) of feature points fails, and the reference image G31 after the image correction is a wider image (larger in lateral magnification) than the inspection image G4 (see FIG. 11f). In this manner, in the case of comparing the reference image G31 failed in alignment of feature points and the inspection image G4, there is a problem in that the accuracy of image inspection cannot be ensured.

This invention has an object to provide an image inspection device, an image forming system, an image inspection method, and a recording medium that can sufficiently ensure the accuracy of image inspection.

To achieve at least one of the abovementioned objects, according to an aspect of the present invention, an image inspection device includes:

a hardware processor, wherein

the hardware processor

captures a read image from a reading device that optically reads a paper sheet output from an image forming device that forms an image on the paper sheet,

aligns a reference image and an inspection image obtained by reading the paper sheet on which an image corresponding to the reference image has been formed with the reading device, at feature points in the images for comparison, and

after performing emphasis processing based on a bias in a detecting direction of an image edge on an image in a feature point extraction region of each of the reference image and the inspection image, performs alignment of the feature points.

According to another aspect of the present invention, an image forming system includes:

an image forming device that forms an image on a paper sheet;

a reading device that optically reads the paper sheet output from the image forming device; and

the image inspection device.

According to still another aspect of the present invention, an image inspection method for an image inspection device includes:

a capturing step of capturing a read image from a reading device that optically reads a paper sheet output from an image forming device that forms an image on the paper sheet; and

an image comparison step of aligning a reference image and an inspection image captured in the capturing step, obtained by reading the paper sheet on which an image corresponding to the reference image has been formed with the reading device, at feature points in the images for comparison, wherein

in the image comparison step, after performing emphasis processing based on a bias in a detecting direction of an image edge on an image in a feature point extraction region of each of the reference image and the inspection image, alignment of the feature points is performed.

According to still another aspect of the present invention, a non-transitory recording medium has a computer-readable program stored therein, causing a computer to function as:

a capturer that captures a read image from a reading device that optically reads a paper sheet output from an image forming device that forms an image on the paper sheet; and

an image comparator that aligns a reference image and an inspection image captured by the capturer, obtained by reading the paper sheet on which an image corresponding to the reference image has been formed with the reading device, at feature points in the images for comparison, wherein

after performing emphasis processing based on a bias in a detecting direction of an image edge on an image in a feature point extraction region of each of the reference image and the inspection image, the image comparator performs alignment of the feature points.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are no intended as a definition of the limits of the present invention.

FIG. 1 is a diagram showing a schematic configuration of an image forming system according to an embodiment.

FIG. 2 is a diagram showing an example of a paper passing route in an in-line scanner.

FIG. 3 is a diagram showing a flow of a paper sheet and data in the image forming system.

FIG. 4 is a flowchart showing an example of an operation of the image forming system according to the present embodiment.

FIG. 5 is a diagram showing an example of a case in which image edges exist both in the main scanning direction and the sub scanning direction.

FIG. 6 is a diagram showing an example of a case in which emphasis processing (low level) has been performed on the image shown in FIG. 5.

FIG. 7 is a diagram showing an example of a case in which an image edge exists in the main scanning direction.

FIG. 8 is a diagram showing an example of a case in which emphasis processing (high level) has been performed on the image shown in FIG. 7.

FIG. 9 is a diagram schematically showing an example of image alignment and image inspection in the present embodiment.

FIG. 10 is a diagram showing an example of emphasis processing (extension processing).

FIG. 11 is a diagram schematically showing an example of conventional image alignment and image inspection.

### DETAILED DESCRIPTION OF THE EMBODIMENTS

Hereinafter, an embodiment of an image inspection device, an image forming system, an image inspection method, and a recording medium of the present invention will be described on the basis of the drawings. However, the scope of the invention is not limited to the disclosed embodiments.

I. Description of Configuration

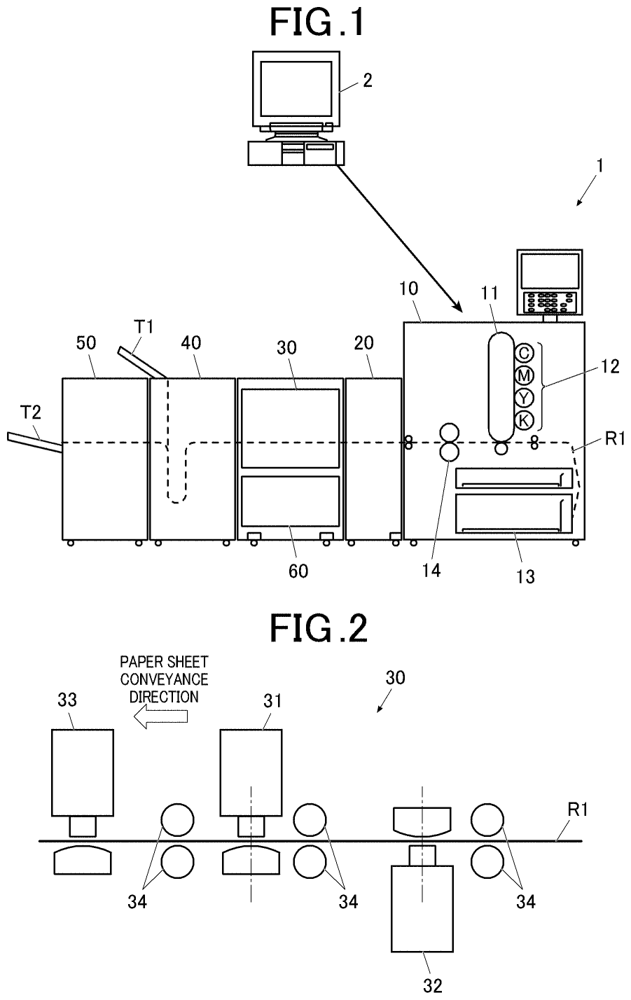

As shown in FIG. 1, an image forming system 1 according to the present embodiment is configured to include an image forming device 10 that receives printing data from an external control device or a server 2, and forms (prints) an image on a paper sheet on the basis of the printing data for output, a relay unit 20 connected to a stage subsequent to the image forming device 10, an in-line scanner 30 connected to a stage subsequent to the relay unit 20, a purge unit 40 connected to a stage subsequent to the in-line scanner 30, a finisher 50 connected to a stage subsequent to the purge unit 40, and an image inspection device 60 that inspects whether or not a printed image is normal for each paper sheet. The reference character R1 in FIG. 1 indicates a conveyance path for paper sheets.

The image forming device 10 is configured to include an endlessly looped intermediate transfer belt 11 and image forming units 12 for respective colors of C (cyan), M (magenta), Y (yellow), and K (black) arranged along this intermediate transfer belt 11, and toner images of respective colors of CMYK are superimposed on the intermediate transfer belt 11 by the image forming units 12 to form a full-color toner image. Then, the image forming device 10 transfers the toner image formed on the intermediate transfer belt 11 onto a paper sheet conveyed from a paper feed tray 13, and further thermally fuses the toner image onto the paper sheet with a fuser 14, and then, outputs the paper sheet toward a device in the subsequent stage (here, the relay unit 20). The image forming device 10 is not limited to one of a tandem-type electrophotographic system as described above, but any system of forming an image on a paper sheet may be employed.

The relay unit 20 relays the paper sheet output from the image forming device 10 further to a device in the subsequent stage (here, the in-line scanner 30). The relay unit 20 has the function of synchronizing the conveyance speed of the paper sheet conveyed from the image forming device 10.

The in-line scanner (reading device) 30 conveys the paper sheet received from the relay unit 20 to the purge unit 40 in the subsequent stage, and scans both the surfaces of the paper sheet during conveyance to optically read images on both the surfaces of the paper sheet, and outputs image data about the read image to the image inspection device 60.

The purge unit 40 conveys a paper sheet determined by the image inspection device 60 that a printed image is normal to the finisher 50 in the subsequent stage, and discharges a paper sheet determined by the image inspection device 60 that a printed image is abnormal to a purge tray T1.

The finisher 50 performs designated post-processing on the paper sheet sent from the purge unit 40, and then discharges the paper sheet to a paper discharge tray T2.

FIG. 2 shows an example of a paper passing route in the in-line scanner 30.

In the in-line scanner 30, an upper side line image sensor 31 that reads the front surface of a paper sheet and a lower side line image sensor 32 that reads the rear surface of the paper sheet are arranged at positions different from each other with a space in the paper sheet conveyance direction in order to read both the surfaces of the paper sheet in one path. In the example shown in FIG. 2, the lower side line image sensor 32 is arranged upstream of the upper side line image sensor 31 in the paper sheet conveyance direction. A colorimeter 33 is provided further downstream of the upper side line image sensor 31.

A paper sheet conveyance mechanism for holding and conveying a paper sheet is provided before and after the respective line image sensors 31 and 32. The paper sheet conveyance mechanism is composed of a pair of conveyor rollers 34 arranged oppositely.

The upper side line image sensor 31 and the lower side line image sensor 32 are fixed at specific places on a conveyance path R1, and a paper sheet being conveyed moves relatively with respect to these reading positions, so that the front and rear sides of the paper sheet are read with the respective line image sensors 31 and 32. In the present embodiment, the direction of conveying a paper sheet will be referred to as the sub scanning direction, and the direction perpendicular to the sub scanning direction on the paper sheet will be referred to as the main scanning direction. The upper side line image sensor 31 and the lower side line image sensor 32 repeat reading a paper sheet conveyed in the sub scanning direction on a line basis in the main scanning direction to read the paper sheet two-dimensionally.

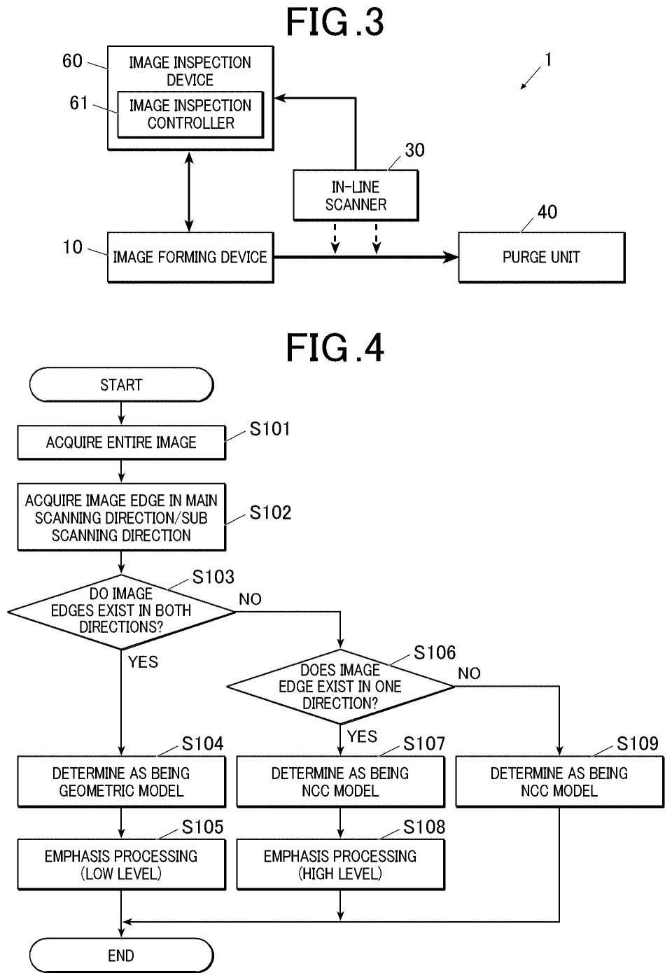

FIG. 3 shows a flow of a paper sheet and data in the image forming system 1.

A paper sheet on which an image has been formed in the image forming device 10 and output is conveyed to the purge unit 40, and on the way, both the surfaces of the paper sheet are read with the in-line scanner 30. The in-line scanner 30 outputs image data obtained by reading toward the image inspection device 60.

The image inspection device 60 is configured to include an image inspection controller 61 (hardware processor).

The image inspection controller 61 functions as a capturer that captures a read image (image data) from the reading device (the in-line scanner 30) that optically reads a paper sheet output from the image forming device 10 that forms an image on the paper sheet and an image comparator that aligns a reference image and an inspection image captured by the capturer, obtained by reading the paper sheet on which an image corresponding to the reference image (an image substantially identical to the reference image) has been formed with the in-line scanner 30 at feature points in the images for comparison. The image inspection controller 61 includes a CPU and a memory, and the CPU reads out and executes a program stored in the memory, so that the functions of the capturer and the image comparator are achieved.

Part or all of the functions of the image inspection device 60 may be configured by a circuit such as an ASIC.

II. Description of Operation

Next, an operation of the image forming system 1 (the image inspection device 60) according to the present embodiment will be described with reference to the flowchart of FIG. 4.

First, the image inspection controller 61 of the image inspection device 60 acquires an image (entire image) obtained by reading a proof with the in-line scanner 30 as a reference image (step S101). The proof has been subjected to adjustment of the image quality and the like through test printing to confirm that there is no problem, and after being printed in the image forming device 10, the entire image is read with the in-line scanner 30.

Next, the image inspection controller 61 analyzes the reference image acquired in step S101 to acquire an image edge (edge information) in the main scanning direction and the sub scanning direction (step S102).

Next, the image inspection controller 61 determines whether or not image edges exist both in the main scanning direction and the sub scanning direction on the basis of the image edges in the main scanning direction and the sub scanning direction acquired in step S102 (step S103). That the image edge exists in the main scanning direction (or the sub scanning direction) indicates a case in which the number of pixels in the main scanning direction (or the sub scanning direction) is more than or equal to predetermined pixels.

In a case where it is determined that the image edges exist both in the main scanning direction and the sub scanning direction (that is, the image edges can be acquired both in the main scanning direction and the sub scanning direction sufficiently (by more than or equal to predetermined pixels)) (YES in step S103), the image inspection controller 61 transitions to the next step S104.

In a case where it is determined that the image edge does not exist in at least one of the main scanning direction and the sub scanning direction (NO in step S103), the image inspection controller 61 transitions to step S106.

In step S104, the image inspection controller 61 determines that the reference image acquired in step S101 is a geometric model. The geometric model refers to an image in which feature points are extracted from the image edge to perform alignment of the feature points.

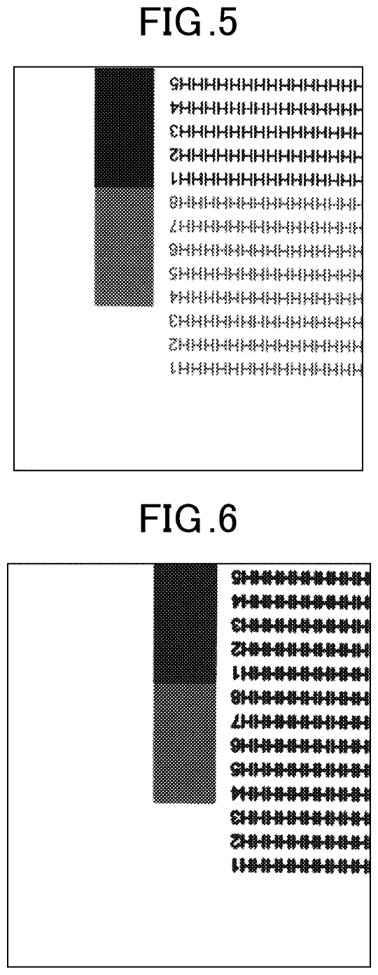

Next, the image inspection controller 61 performs emphasis processing (low level) which is second emphasis processing on the reference image determined as being a geometric model in step S104 (step S105), and terminates the process. FIG. 5 shows an example of a case in which the image edges exist both in the main scanning direction and the sub scanning direction. FIG. 6 shows an example of a case in which emphasis processing (low level) has been performed on the image shown in FIG. 5.

In step S106, the image inspection controller 61 determines whether or not the image edge exists in either one of the main scanning direction and the sub scanning direction on the basis of the image edges in the main scanning direction and the sub scanning direction acquired in step S102.

In a case where it is determined that the image edge exists in either one of the main scanning direction and the sub scanning direction (that is, the image edge can be acquired in either one of the main scanning direction and the sub scanning direction by more than or equal to the predetermined pixels) (YES in step S106), the image inspection controller 61 transitions to the next step S107.

In a case where it is determined that the image edge exists in neither one of the main scanning direction and the sub scanning direction (that is, the image edge can be acquired in neither one of the main scanning direction and the sub scanning direction sufficiently (by more than or equal to the predetermined pixels)) (NO in step S106), the image inspection controller 61 transitions to step S109.

In step S107, the image inspection controller 61 determines that the reference image acquired in step S101 is an NCC model. The NCC model refers to an image for which alignment through image matching (alignment of target regions through normalized cross correlation) is performed.

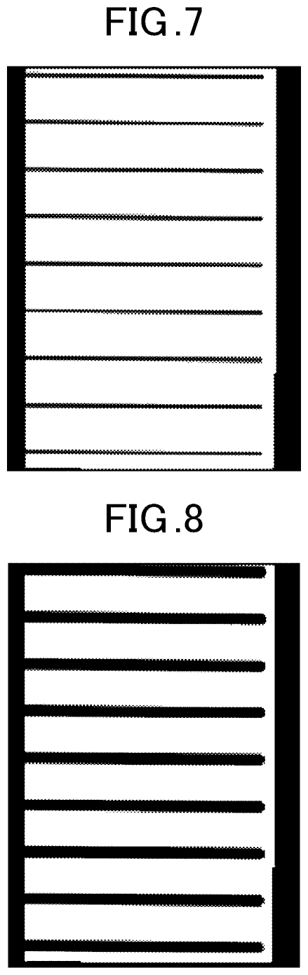

Next, the image inspection controller 61 performs emphasis processing (high level) which is first emphasis processing on the reference image determined as being an NCC model in step S107 (step S108), and terminates the process. FIG. 7 shows an example of a case in which the image edge exists in the main scanning direction. FIG. 8 shows an example of a case in which the emphasis processing (high level) has been performed on the image shown in FIG. 7.

In step S109, the image inspection controller 61 determines that the reference image acquired in step S101 is an NCC model. At this time, since the image edge can be acquired in neither one of the main scanning direction and the sub scanning direction sufficiently (by more than or equal to the predetermined pixels), the image inspection controller 61 does not perform the emphasis processing on the reference image unlike the case in which the image edge can be acquired in at least one of the main scanning direction and the sub scanning direction. In this case, alignment between a reference image G11 and an inspection image G2 through image matching (alignment of target regions through normalized cross correlation) will be performed.

Thereafter, the image inspection controller 61 acquires an image (entire image) obtained by reading a paper sheet (a paper sheet targeted for inspection) on which an image corresponding to the reference image has been formed with the in-line scanner 30 as an inspection image, and performs processing similar to the processing performed on the reference image. That is, in a case where the emphasis processing (low level) is performed on the reference image, the emphasis processing (low level) will be performed on the inspection image, and in a case where the emphasis processing (high level) is performed, the emphasis processing (high level) will be performed. In a case where the emphasis processing has not been performed on the reference image, the emphasis processing will not be performed on the inspection image.

Then, the image inspection controller 61 extracts a feature point from each of the reference image and the inspection image having been subjected to the emphasis processing (high level), and compares the feature points to calculate the amount of positional deviation. Thereafter, the image inspection controller 61 performs image correction (affine transformation or the like) on the original reference image (the reference image before being subjected to the emphasis processing (high level)) on the basis of the calculated amount of positional deviation to perform alignment (matching) of the feature points, and then compares the reference image after the image correction and the inspection image to perform image inspection.

The image inspection controller 61 performs alignment of the reference image having been subjected to the emphasis processing (low level) or the reference image not having been subjected to the emphasis processing and the inspection image through image matching, and then compares the reference image and the inspection image to perform image inspection.

That is, the image inspection controller 61 changes the method of aligning the feature points on the basis of a bias in detecting direction of the image edge. The bias in detecting direction of the image edge refers to a pattern of the detecting direction of the image edge, and specifically includes a pattern in which image edges exist both in the main scanning direction and the sub scanning direction (the image edges can be acquired both in the main scanning direction and the sub scanning direction by more than or equal to predetermined pixels), a pattern in which an image edge exists in either one of the main scanning direction and the sub scanning direction (the image edge can be acquired in either one of the main scanning direction and the sub scanning direction by more than or equal to the predetermined pixels), and a pattern in which an image edge exists in neither one of the main scanning direction and the sub scanning direction (an image edge can be acquired in neither one of the main scanning direction and the sub scanning direction by more than or equal to predetermined pixels).

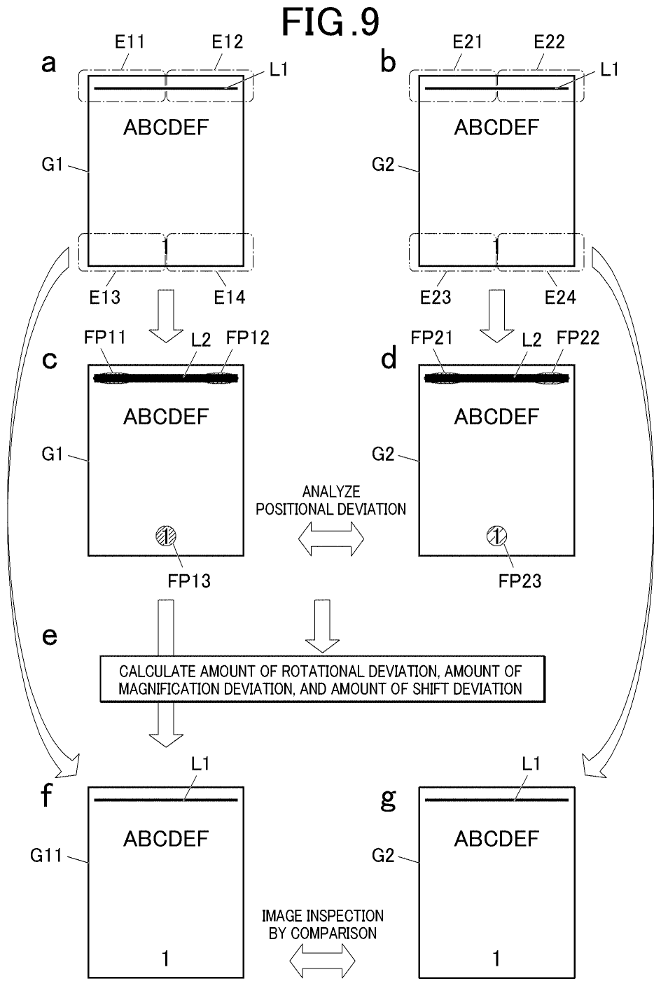

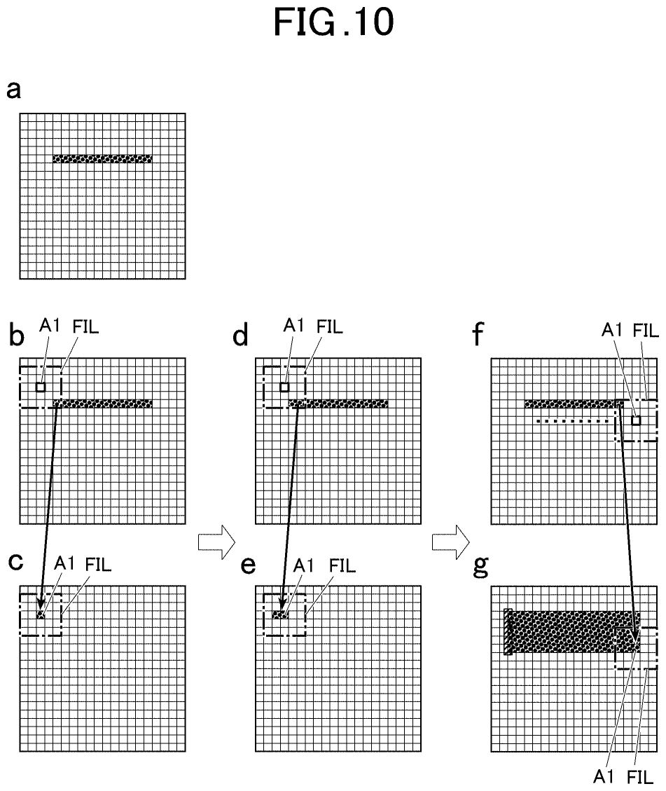

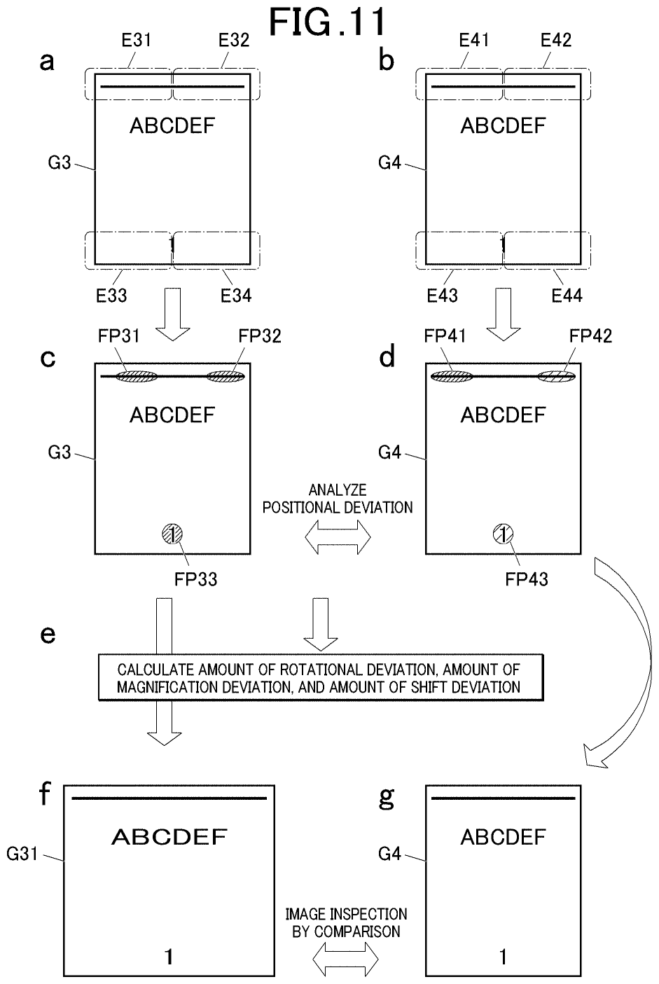

FIG. 9 schematically shows an example of image alignment and image inspection in the present embodiment.

First, the image inspection controller 61 sets four regions (feature point extraction regions E11 to E14) for extracting feature points for a reference image G1 (see FIG. 9a). Similarly, the image inspection controller 61 sets four feature point extraction regions E21 to E24 for the inspection image G2 (see FIG. 9b).

Next, the image inspection controller 61 performs emphasis processing based on the bias in detecting direction of the image edge on images of the feature point extraction regions E11 to E14 set for the reference image Gl. For example, in the feature point extraction regions E11 and E12, a single thin ruled line L1 is drawn. In the case of this thin ruled line L1, the detecting direction of the image edge is biased to either one of the main scanning direction and the sub scanning direction. Thus, the emphasis processing (high level) is performed (see FIG. 9c). Thereafter, the image inspection controller 61 extracts the feature points FP11 to FP13 on the basis of an image L2 having been subjected to the emphasis processing (high level) (see FIG. 9c). Similarly, the image inspection controller 61 performs the emphasis processing based on the bias in detecting direction of the image edge (emphasis processing (high level) on the thin ruled line L1) on images in the feature point extraction regions E21 to E24 set for the inspection image G2, and then extracts the feature points FP21 to FP23 (see FIG. 9d).

Next, the image inspection controller 61 compares (analyzes) the feature points FP11 to FP13 and the feature points FP21 to FP23 as extracted to calculate the amount of positional deviation (the amount of deviation in rotation angle (the amount of rotational deviation), the amount of deviation in magnification (X/Y) (the amount of magnification deviation), and the amount of deviation in shift (X/Y) (the amount of shift deviation)) (see FIG. 9e).

Next, the image inspection controller 61 performs image correction (affine transformation or the like) on the original reference image (the reference image before being subjected to the emphasis processing (high level)) G1 on the basis of the calculated amount of positional deviation to perform alignment (matching) of feature points (see FIG. 9f). The purpose of performing image correction on the reference image G1 rather than on the inspection image G2 is to prevent information about a stain in the inspection image G2 or the like from being lost by the image correction.

Thereafter, the reference image G11 after the image correction and the inspection image G2 (see FIG. 9g) are compared to perform image inspection.

Since the emphasis processing (high level) is performed on the thin ruled line L1 in the example shown in FIG. 9, the image edge at the end of the image L2 can be acquired precisely (see the reference character FP11 in FIG. 9c). Accordingly, alignment (matching) of feature points can be performed with high accuracy, so that the accuracy of image inspection performed by comparing the reference image G11 after the image correction and the inspection image G2 can be ensured sufficiently.

FIG. 10 shows an example of extension processing (processing of thickening a line) which is one of the emphasis processing. A single square shown in FIG. 10 corresponds to a pixel.

First, a 5 (square)×5 (square) filter FIL is set for an original image (see FIG. 10a) such that one square at the lower right matches a square at the left end of the original image (see FIG. 10b). At this time, the maximum pixel value in the 5×5 filter FIL is copied to a pixel of interest (the central square of the 5×5 filter FIL) Al (see FIG. 10c).

Next, the 5×5 filter FIL is shifted to the right in the drawing by one square (one pixel) (see FIG. 10d). At this time, the maximum pixel value in the 5×5 filter FIL is also copied to the pixel of interest A1, similarly to FIG. 10c described above (see FIG. 10e).

Thereafter, the 5×5 filter FIL is shifted in the horizontal direction (to the right in the drawing) by one square (one pixel) until one square at the lower left matches a square at the right end of the original image. Subsequently, the maximum pixel value is copied to the pixel of interest Al each time a shift is performed by one square.

Thereafter, after being returned to the position shown in FIG. 10b, the 5×5 filter FIL is shifted downward by one square. Then, similarly to the foregoing, the 5×5 filter FIL is shifted in the horizontal direction (to the right in the drawing) by one square (one pixel) until a square at the lower left matches a square at the right end of the original image.

The above-described processing is repeated to the uppermost row of the 5×5 filter FIL (see FIG. 10f). Accordingly, the original image can be thickened (extended) by two pixels in the vertical direction and lateral direction, respectively (see FIG. 10g).

III. Effects

As described above, the image inspection device 60 according to the present embodiment includes the capturer (the image inspection controller 61) that captures a read image from the reading device (the in-line scanner 30) that optically reads a paper sheet output from the image forming device 10 that forms an image on the paper sheet, and the image comparator (the image inspection controller 61) that aligns a reference image and an inspection image captured by the capturer, obtained by reading the paper sheet on which an image corresponding to the reference image has been formed with the reading device, at feature points in the images for comparison. The image comparator performs alignment of the feature points after performing the emphasis processing based on the bias in detecting direction of the image edge on an image in a feature point extraction region of each of the reference image and the inspection image.

Therefore, in accordance with the image inspection device 60 according to the present embodiment, alignment of feature points can be performed with high accuracy even in a case where an image such as a thin ruled line has been formed on a paper sheet, so that the accuracy of image inspection can be ensured sufficiently.

In accordance with the image inspection device 60 according to the present embodiment, the emphasis processing is extension processing.

Therefore, in accordance with the image inspection device 60 according to the present embodiment, the image edge detection accuracy can be improved. Thus, alignment of feature points can be performed with high accuracy, so that the accuracy of image inspection can be ensured sufficiently.

In accordance with the image inspection device 60 according to the present embodiment, the image comparator performs first emphasis processing in a case where an image edge can be acquired in either one of the main scanning direction and the sub scanning direction by more than or equal to predetermined pixels, and performs second emphasis processing lower in degree of emphasis than the first emphasis processing in a case where image edges can be acquired both in the main scanning direction and the sub scanning direction by more than or equal to the predetermined pixels.

Therefore, in accordance with the image inspection device 60 according to the present embodiment, emphasis processing can be performed to a necessary degree according to necessity on the basis of information about the image edge. Thus, alignment of feature points can be performed more reliably, so that the accuracy of image inspection can be improved more reliably.

In accordance with the image inspection device 60 according to the present embodiment, the image comparator does not perform the emphasis processing in a case where an image edge can be acquired in neither one of the main scanning direction and the sub scanning direction by more than or equal to the predetermined pixels.

Therefore, in accordance with the image inspection device 60 according to the present embodiment, unnecessary emphasis processing can be prevented from being performed in a case where it is determined on the basis of the information about the image edge that it is difficult to extract feature points from the image edge to perform alignment of the feature points. Thus, burdens related to image inspection can be reduced.

In accordance with the image inspection device 60 according to the present embodiment, the image comparator changes the method of aligning feature points on the basis of the bias in detecting direction of the image edge.

Therefore, in accordance with the image inspection device 60 according to the present embodiment, an optimum alignment method can be selected in accordance with information about the image edge. Thus, alignment of the feature points can be performed with high accuracy, so that the accuracy of image inspection can be ensured sufficiently.

In accordance with the image inspection device 60 according to the present embodiment, in a case where image edges can be acquired both in the main scanning direction and the sub scanning direction by more than or equal to predetermined pixels, the image comparator extracts feature points from the image edges to perform alignment of the feature points, and in a case where an image edge can be acquired in either one of the main scanning direction and the sub scanning direction by more than or equal to the predetermined pixels or in a case where an image edge can be acquired in neither one of the main scanning direction and the sub scanning direction by more than or equal to the predetermined pixels, the image comparator performs alignment of target regions through normalized cross correlation.

Therefore, in accordance with the image inspection device 60 according to the present embodiment, an optimum alignment method can be selected in accordance with information about the image edge. Thus, alignment of the feature points can be performed with high accuracy, so that the accuracy of image inspection can be ensured sufficiently.

Although specific description has been provided above on the basis of an embodiment according to the present invention, the present invention is not limited to the above-described embodiment, but can be modified within a range not departing from its substance.

For example, although an image (entire image) obtained by reading a proof with the in-line scanner 30 is acquired as a reference image in the above-described embodiment, this is not a limitation. For example, an original image acquired from the server 2 may be acquired as a reference image.

Although the extension processing (processing of thickening a line) has been illustrated and described as the emphasis processing in the above-described embodiment, this is not a limitation. That is, the processing may be any type of processing capable of emphasizing the image edge in order to facilitate identification of the image edge, and processing of increasing the density of an image (density correction processing) may be employed, for example.

In this manner, the image edge detection accuracy can be improved by employing the density correction processing as the emphasis processing. Thus, alignment of feature points can be performed with high accuracy, so that the accuracy of image inspection can be ensured sufficiently.

In the above-described embodiment, in a case where image edges can be acquired both in the main scanning direction and the sub scanning direction by more than or equal to predetermined pixels, feature points are extracted from the image edges to perform alignment of the feature points, and in a case where an image edge can be acquired in either one of the main scanning direction and the sub scanning direction by more than or equal to the predetermined pixels or in a case where an image edge can be acquired in neither one of the main scanning direction and the sub scanning direction by more than or equal to the predetermined pixels, alignment of target regions through normalized cross correlation is performed, but this is not a limitation. For example, in a case where an image edge can be acquired in at least one of the main scanning direction and the sub scanning direction by more than or equal to the predetermined pixels, feature points may be extracted from the image edge to perform alignment of the feature points, and in a case where an image edge can be acquired in neither one of the main scanning direction and the sub scanning direction by more than or equal to the predetermined pixels, alignment of target regions through normalized cross correlation may be performed.

In this manner, in a case where an image edge can be acquired in at least one of the main scanning direction and the sub scanning direction by more than or equal to predetermined pixels, the image comparator extracts feature points from the image edge to perform alignment of the feature points, and in a case where an image edge can be acquired in neither one of the main scanning direction and the sub scanning direction by more than or equal to the predetermined pixels, the image comparator performs alignment of target regions through normalized cross correlation. Accordingly, an optimum alignment method can be selected in accordance with information about the image edge. Thus, alignment of the feature points can be performed with high accuracy, so that the accuracy of image inspection can be ensured sufficiently.

In addition, a detailed configuration of each device that constitutes the image forming system and a detailed operation of each device can also be modified as appropriate within a range not departing from the substance of the present invention.

Although embodiments of the present invention have been described and illustrated in detail, the disclosed embodiments are made for purposes of illustration and example only and not limitation. The scope of the present invention should be interpreted by terms of the appended claims

What is claimed is:

1. An image inspection device comprising:
a hardware processor, wherein
the hardware processor
captures a read image from a reading device that optically reads a paper sheet output from an image forming device that forms an image on the paper sheet,
aligns a reference image and an inspection image obtained by reading the paper sheet on which an image corresponding to the reference image has been formed with the reading device, at feature points in the images for comparison, and
after performing emphasis processing based on a bias in a detecting direction of an image edge on an image in a feature point extraction region of each of the reference image and the inspection image, performs alignment of the feature points.

2. The image inspection device according to claim 1, wherein the emphasis processing is extension processing.

3. The image inspection device according to claim 1, wherein the emphasis processing is density correction processing.

4. The image inspection device according to claim 1, wherein the hardware processor performs first emphasis processing in a case where the image edge can be acquired in either one of a main scanning direction and a sub scanning direction by more than or equal to predetermined pixels, and performs second emphasis processing lower in degree of emphasis than the first emphasis processing in a case where the image edge can be acquired both in the main scanning direction and the sub scanning direction by more than or equal to the predetermined pixels.

5. The image inspection device according to claim 1, wherein the hardware processor does not perform first emphasis processing in a case where the image edge can be acquired neither in a main scanning direction and a sub scanning direction by more than or equal to predetermined pixels.

6. The image inspection device according to claim 1, wherein the hardware processor changes a method of aligning the feature points on a basis of the bias in the detecting direction of the image edge.

7. The image inspection device according to claim 6, wherein the hardware processor extracts feature points from the image edge to perform alignment of the feature points in a case where the image edge can be acquired both in the main scanning direction and the sub scanning direction by more than or equal to predetermined pixels, and performs alignment of target regions through normalized cross correlation in a case where the image edge can be acquired in either one of the main scanning direction and the sub scanning direction by more than or equal to the predetermined pixels or in a case where the image edge can be acquired in neither one of the main scanning direction and the sub scanning direction by more than or equal to the predetermined pixels.

8. The image inspection device according to claim 6, wherein the hardware processor extracts feature points from the image edge to perform alignment of the feature points in a case where the image edge can be acquired in at least one of the main scanning direction and the sub scanning direction by more than or equal to predetermined pixels, and performs alignment of target regions through normalized cross correlation in a case where the image edge can be acquired in neither one of the main scanning direction and the sub scanning direction by more than or equal to the predetermined pixels.

9. An image forming system comprising:
an image forming device that forms an image on a paper sheet;
a reading device that optically reads the paper sheet output from the image forming device; and
the image inspection device as defined in claim 1.

10. An image inspection method for an image inspection device, the image inspection method comprising:
a capturing step of capturing a read image from a reading device that optically reads a paper sheet output from an image forming device that forms an image on the paper sheet; and
an image comparison step of aligning a reference image and an inspection image captured in the capturing step, obtained by reading the paper sheet on which an image corresponding to the reference image has been formed with the reading device, at feature points in the images for comparison, wherein
in the image comparison step, after performing emphasis processing based on a bias in a detecting direction of an image edge on an image in a feature point extraction region of each of the reference image and the inspection image, alignment of the feature points is performed.

11. A non-transitory recording medium having a computer-readable program stored therein, causing a computer to function as:
a capturer that captures a read image from a reading device that optically reads a paper sheet output from an image forming device that forms an image on the paper sheet; and
an image comparator that aligns a reference image and an inspection image captured by the capturer, obtained by reading the paper sheet on which an image corresponding to the reference image has been formed with the reading device, at feature points in the images for comparison, wherein
after performing emphasis processing based on a bias in a detecting direction of an image edge on an image in a feature point extraction region of each of the reference image and the inspection image, the image comparator performs alignment of the feature points.
